(19) United States
(12) Patent Application Publication
(10) Pub. No.: US 2026/0084680 A1
(43) Pub. Date: Mar. 26, 2026

(54) DRIVING FORCE CONTROL SYSTEM FOR HYBRID VEHICLE

(71) Applicant: TOYOTA JIDOSHA KABUSHIKI KAISHA, Toyota-shi (JP)

(72) Inventors: Yuji MATSUMURA, Toyota-shi (JP); Masato YOSHIKAWA, Nagakute-shi (JP); Akihito HAYASAKA, Nisshin-shi (JP)

(73) Assignee: TOYOTA JIDOSHA KABUSHIKI KAISHA, Toyota-shi (JP)

(21) Appl. No.: 19/328,980

(22) Filed: Sep. 15, 2025

(30) Foreign Application Priority Data
Sep. 26, 2024 (JP) 2024-167273

(51) Int. Cl. B60W 10/06; B60W 20/17

(52) U.S. Cl. CPC B60W 10/06; B60W 20/17; B60W 2510/083; B60W 2540/10; B60W 2710/0666

(57) ABSTRACT

A driving force control system for a hybrid vehicle configured to realize the behavior of the hybrid vehicle expected by a driver. The hybrid vehicle has an engine and a motor for generating a system torque to achieve a required driving force. A controller of the control system comprises: a first acceleration controller configured to increase an engine torque with an increase in the system torque; a second acceleration controller configured to restrict the engine torque to a predetermined torque; and a third acceleration controller configured to increases the engine torque to achieve the system torque.

### CROSS-REFERENCE TO RELATED APPLICATIONS

The present disclosure claims the benefit of Japanese Patent Application No. 2024-167273 filed on Sep. 26, 2024 with the Japanese Patent Office, the disclosures of which are incorporated herein by reference in its entirety.

### BACKGROUND

### Field of the Disclosure

Embodiments of the present disclosure relate to the art of a driving force control system for a hybrid vehicle in which a prime mover includes an internal combustion engine and a motor.

### Discussion of the Related Art

JP-A-2023-84040 describes a control apparatus of a hybrid vehicle in which an engine, a motor, a torque converter, and a transmission are arranged on a torque transmission path in the above-described order. According to the teachings of JP-A-2023-84040, in an HEV mode in which the vehicle is propelled by a power of the engine, the engine is controlled to generate a torque to achieve a target system axial torque delivered to a torque converter at least partially, and the motor is controlled to generate a torque to compensate for the shortfall of the torque with respect to the target system axial torque which cannot be generated only by the engine.

In the hybrid vehicle to which the control apparatus taught by JP-A-2023-84040 is applied, the engine torque is increased with an increase in the target system axial torque to achieve the target system axial torque when launching or accelerating the vehicle. In this situation, if the target system axial torque may be achieved only by the torque of the engine, the motor does not generate the torque. In other words, the torque of the engine is increased with the increase in the target system axial torque. Consequently, noise of the engine increases with the increase in the torque of the engine.

The driver of the hybrid vehicle expects to propel the vehicle using the power of the motor in addition to the engine. Therefore, when the torque of the engine increases with the increase in the target system axial torque when launching or accelerating the vehicle, the driver may get the impression that the vehicle is propelled only by the power of the engine. That is, the actual behavior and sound of the vehicle may be different from the behavior and sound of the vehicle expected by the driver, and as a result, the driver may feel frustrated.

### SUMMARY

Aspects of embodiments of the present disclosure have been conceived noting the foregoing technical problems, and it is therefore an object of the present disclosure to provide a driving force control system for a hybrid vehicle configured to realize a behavior of the hybrid vehicle expected by the driver.

According to the exemplary embodiment the present disclosure, there is provided a driving force control system for a hybrid vehicle having a prime mover including an engine and a motor that generates a system torque to achieve a required driving force to propel the hybrid vehicle. In order to achieve the above-explained objective, the driving force control system is provided with a controller that controls torques of the engine and the motor. According to the exemplary embodiment the present disclosure, the controller comprises: a first acceleration controller that is configured to increase the torque of the engine to a predetermined torque with an increase in the system torque; a second acceleration controller that is configured to restrict the torque of the engine which has been increased to the predetermined torque to the predetermined torque or less within a predetermined period of time; and a third acceleration controller that is configured to increase the torque of the engine which has been restricted by the second acceleration controller to achieve the system torque.

In a non-limiting embodiment, the controller may further comprise a lower guard determiner that is configured to set a lower limit torque of the engine to a torque calculated by subtracting a torque corresponding to the maximum torque of the motor from the system torque.

In a non-limiting embodiment, the predetermined torque may include a torque by which a sound pressure level of noise generated by operating the engine is suppressed to a maximum sound pressure level at which the noise of the engine cannot be perceived by an occupant.

In a non-limiting embodiment, the controller may further comprise an acceleration determiner that is configured to determine that a driver has an intention to accelerate the hybrid vehicle based on a fact that a target value of the system torque is increased to a predetermined determination torque or larger. In addition, the predetermined torque may include the determination torque.

In a non-limiting embodiment, the determination torque may be set to a larger torque with an increase in a speed of the hybrid vehicle.

Thus, according to present disclosure, the system torque to achieve a driving force required to propel the vehicle is generated by the engine and the motor. When the system torque increases, the torque of the engine is increased to the predetermined torque in accordance with an increase in the system torque, and the torque of the engine is maintained to the predetermined torque. That is, while the system torque increases, the torque of the engine is not increased, and a shortage of the torque to propel the vehicle is generated by the motor. Then, the torque of the engine is increased toward the system torque. By thus maintaining the torque of the engine to the predetermined torque, the sound pressure generated from the engine may be suppressed even when the vehicle is accelerated, and the driver is allowed to recognize that the driving force is established by the power of the motor. In other words, the behavior of the hybrid vehicle expected by the driver may be realized. In addition, by thus increasing the torque of the engine to the predetermined torque and generating the torque by the motor to achieve the system torque, it is possible to suppress an increase in the torque required to be generated by the motor. Therefore, even if the hybrid vehicle is equipped with a motor whose maximum torque is relatively small, an expected behavior of the hybrid vehicle may be realized.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the hybrid vehicle to which the driving force control system according to the exemplary embodiment of the present disclosure is applied;

FIG. 2 is a block diagram showing functions of the driving force control system according to the exemplary embodiment of the present disclosure;

FIG. 3 is a flowchart showing a one example of a routine for determining a limit torque of the engine;

FIG. 4 is a time chart showing a change in the engine torque during execution of the routine shown in FIG. 3;

FIG. 5 is a flowchart showing one example of a routine for determining the limit torque of the engine based on the torque at a point when an execution of an accelerating operation is determined; and

FIG. 6 is a time chart showing a change in the engine torque in a situation where a determination torque is larger than a sound pressure limiting torque.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure, and do not limit the present disclosure.

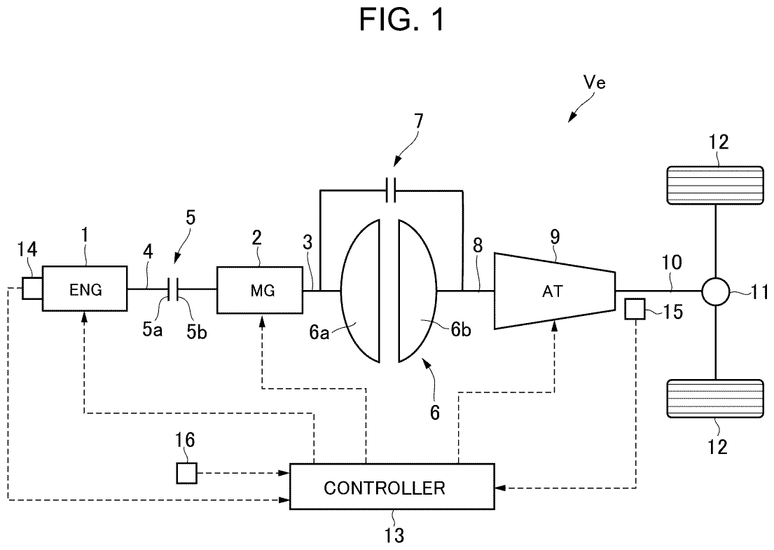

Referring now to FIG. 1, there is shown one example of a structure of a vehicle Ve to which the driving force control system according to the exemplary embodiment of the present disclosure is applied. The vehicle Ve shown in FIG. 1 is a hybrid vehicle in which a prime mover includes an engine (referred to as “ENG” in FIG. 1) 1, and a motor (referred to as “MG” in FIG. 1) 2. As the conventional engines, the engine 1 generates a torque by mixing fuel and air such as gasoline and diesel in cylinders and igniting the air-fuel mixture.

For example, an AC motor such as a synchronous motor or an induction motor arranged in conventional electric vehicles or hybrid vehicles to serve as a prime mover may be adopted as the motor 2. The motor 2 serves as a motor by supplying electric power thereto to generate a drive torque, and serves as a generator by rotating a rotor shaft 3 thereof passively to translate at least a part of power rotating the rotor shaft 3 into electric power.

The rotor shaft 3 protrudes from both sides of a rotor (not shown) in the axis direction, and an output shaft (i.e., a crankshaft) 4 of the engine 1 is connected to the rotor shaft 3 of the motor 2 through a clutch mechanism 5. The clutch mechanism 5 comprises a clutch plate 5a and a clutch disk 5b opposed to each other. Specifically, the clutch plate 5a is connected to the output shaft 4 of the engine 1, and the clutch disk 5b is connected to the rotor shaft 3 of the motor 2. For example, a friction clutch that transmits a torque according to a hydraulic pressure applied thereto or an electric power supplied thereto may be adopted as the clutch mechanism 5. Alternatively, a dog clutch may also be adopted as the clutch mechanism 5.

An end portion of the rotor shaft 3 on the output side of the motor 2 (i.e., the opposite side to the engine 1) is connected to a torque converter 6. The torque converter 6 comprises a pump impeller 6a connected to the rotor shaft 3, and a turbine runner 6b opposed to the pump impeller 6a. The torque converter 6 may be provided with a stator for redirecting a fluid discharged from the turbine runner 6b. In addition, a lockup clutch 7 is arranged in the vehicle Ve to adjust a speed difference between the pump impeller 6a and the turbine runner 6b to a desired value, and to rotate the pump impeller 6a and the turbine runner 6b integrally.

A geared automatic transmission (hereinafter, simply referred to as a transmission mechanism) 9 that changes a speed ratio stepwise is connected to an output shaft 8 of the torque converter 6. For example, a conventional geared automatic transmission configured to shift a gear stage among the first to sixth forward stages and the first reverse stage may be adopted as the transmission mechanism 9. Instead, a belt driven continuously variable transmission that changes a speed ratio continuously by changing a running radius of a belt, and a toroidal continuously variable transmission that changes a speed ratio continuously by changing an inclination angle of a power roller may also be employed as the transmission mechanism 9. In addition, a hybrid continuously variable transmission mechanism in which the engine 1, a speed change motor (not shown), and an output shaft 10 are connected through a differential mechanism, and a speed of the engine 1 is continuously varied by changing a rotational speed of the speed change motor may also be employed as the transmission mechanism 9.

A pair of drive wheels 12 is connected to the output shaft 10 of the transmission mechanism 9 through a differential gear unit 11.

In order to control the engine 1, the motor 2, and the transmission mechanism 9, the vehicle Ve is provided with a controller 13. The controller 13 comprises a microcomputer configured to transmit a command signal for controlling the engine 1, the motor 2, and the transmission mechanism 9 based on incident signals, with reference to maps and using arithmetic expressions stored in advance.

In the vehicle Ve shown in FIG. 1, the controller 13 receives signals from a crank angle sensor 14 that detects the rotational speed of the output shaft 4 of the engine 1, a vehicle speed sensor 15 that detects a speed of the vehicle Ve, and an accelerator sensor 16 that detects a required driving force. The vehicle speed sensor 15 is adapted to detect a rotational speed of a rotary member whose rotational speed changes in accordance with a speed of the vehicle Ve. In the example shown in FIG. 1, specifically, the vehicle speed sensor 15 detects a rotational speed of the output shaft 10 of the transmission mechanism 9, and the accelerator sensor 16 detects an operating amount or a position of an accelerator device such as an accelerator pedal (not shown).

In order to select a gear stage (i.e., a speed ratio) of the transmission mechanism 9, a shift map is stored in the controller 13. The shift map is configured to select a gear stage of the transmission mechanism 9 based on a position of the accelerator pedal detected by the accelerator sensor 16 and a speed of the vehicle Ve detected by the vehicle speed sensor 15. Specifically, the shift map is configured to set a plurality of upshift lines and a plurality of downshift lines using a position of the accelerator pedal and a speed of the vehicle Ve as parameters. For example, an upshifting of the transmission mechanism 9 is executed when the speed of the vehicle Ve increases across the upshift line or when the position of the accelerator pedal is returned across the upshift line, and a downshifting of the transmission mechanism 9 is executed when the speed of the vehicle Ve decreases across the downshift line or when the accelerator pedal is depressed across the across the downshift line.

An operating mode of the vehicle Ve may be selected from an EV mode in which the vehicle Ve is propelled by the motor 2, and an HV mode in which the vehicle Ve is propelled by the engine 1 or the engine 1 and the motor 2. That is, in the EV mode, a power to propel the vehicle Ve is generated only by the motor 2. To this end, specifically, the power required to propel the vehicle Ve is calculated based on a position of the accelerator pedal and a speed of the vehicle Ve, and an electric power corresponding to the calculated power is supplied to the motor 2. Since a rotational speed of the motor 2 is governed by the gear stage of the transmission mechanism 9 and the speed of the vehicle Ve, a torque of the motor 2 is determined by dividing the power to propel the vehicle Ve by the rotational speed of the motor 2.

Whereas, in the HV mode, the power required to propel the vehicle Ve is generated not only by the engine 1 but also by the engine 1 and the motor 2. For example, when cruising the vehicle Ve in the HV mode, a target system torque of the rotor shaft 3 is calculated based on a driving force required to propel the vehicle Ve and the gear stage of the transmission mechanism 9, and a torque of the engine 1 is controlled so as to achieve the calculated target system torque. When the torque of the engine 1 is different from the target system torque due to a delay in a change in the torque of the engine 1 or due to a fluctuation of the torque of the engine 1, the motor 2 generates a torque corresponding to a difference between the target system torque and the torque of the engine 1.

For example, when the torque of the engine 1 is larger than the target system torque, the motor 2 is operated as a generator to regenerate an excess torque. By contrast, when the engine torque is smaller than the target system torque, the motor 2 is operated as a motor to generate a torque to offset a shortage. When the engine torque is comparable to the target system torque, the motor 2 does not generate a torque.

When the required driving force to propel the vehicle Ve is increased during propulsion in the HV mode, the controller 13 prevents an increase in engine noise with such increase in the required driving force. Specifically, the controller 13 is configured to suppress the increase in the engine noise by restricting the torque of the engine 1 while the required driving force is being increased.

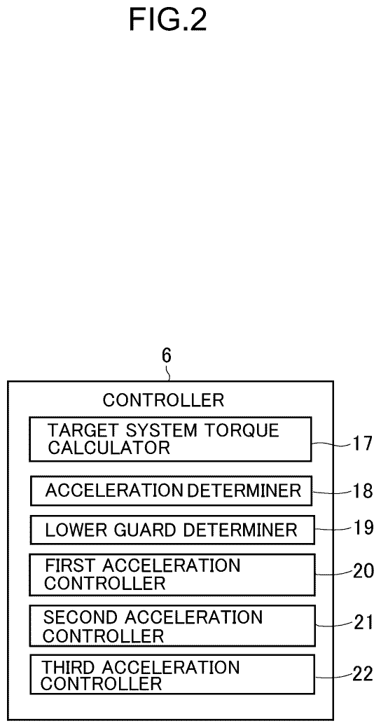

FIG. 2 is a block diagram for explaining functions of the controller 13 for restricting the torque of the engine 1 as described above. As shown in FIG. 2, the controller 13 comprises a target system torque calculator 17, an acceleration determiner 18, a lower guard determiner 19, a first acceleration controller 20, a second acceleration controller 21, and a third acceleration controller 22.

The target system torque calculator 17 is configured to calculate the above-mentioned target system torque based on a required driving force to propel the vehicle Ve and a speed ratio of the transmission mechanism 9 including the torque converter 6.

The acceleration determiner 18 is configured to determine whether or not the driver has operated the accelerator pedal with the intention to accelerate the vehicle Ve. Specifically, the acceleration determiner 18 determines whether a position of the accelerator pedal detected by the accelerator sensor 16 is deeper than a predetermined position. It is to be noted that the predetermined position is set to a deeper position with an increase in a speed of the vehicle Ve.

The lower guard determiner 19 is configured to set a lower limit torque of the engine 1. Specifically, in order to control the torques of the engine 1 and the motor 2 to achieve the driving force required by the driver to propel the vehicle Ve on a priority basis, the lower guard determiner 19 sets the lower limit torque of the engine 1 to a torque calculated by subtracting the maximum torque of the motor 2 from the target system torque.

The first acceleration controller 20 is configured to control the torque of the engine 1 according to a position of the accelerator pedal in the initial phase of accelerating the vehicle Ve. Specifically, the first acceleration controller 20 increases the torque of the engine 1 with an increase in the target system torque in the initial phase of accelerating the vehicle Ve.

The second acceleration controller 21 is configured to restrict the torque of the engine 1 to a predetermined torque or less in an intermediate phase of accelerating the vehicle Ve. Specifically, the second acceleration controller 21 limits the torque of the engine 1 to or less than a torque by which a level of a sound pressure of the noise generated by the engine 1 being operated is suppressed to a maximum sound pressure level at which the noise of the engine 1 cannot be perceived by an occupant (hereinafter, referred to as the sound pressure limiting torque). Alternatively, the second acceleration controller 21 limits the torque of the engine 1 to or less than a torque corresponding to a position of the accelerator pedal at which a fact that the accelerator pedal is depressed to accelerate the vehicle Ve is to be determined (hereinafter referred to as the determination torque). The above-mentioned sound pressure limiting torque and determination torque correspond to the “predetermined torque” of the exemplary embodiment of the present disclosure.

Specifically, the sound pressure level rises with an increase in the torque of the engine 1, and a frequency of the engine noise increases with an increase in the speed of the engine 1. Whereas, the sound pressure descends with an increase in the speed of the engine 1. Therefore, the maximum sound pressure level at which the engine noise cannot be perceived by the occupant is determined based on a result of an experiment conducted in advance, and the torque of the engine 1 at which the sound pressure generated by the engine 1 is suppressed to the above-mentioned maximum sound pressure level is set as the sound pressure limiting torque.

The third acceleration controller 22 is configured to reduce a difference between the target system torque and the torque of the engine 1. Specifically, the third acceleration controller 22 increases the torque of the engine 1 by a predetermined amount. The predetermined amount is determined based on an amount of change in the sound pressure level by which the occupant will not feel uncomfortable even if the sound pressure level of the engine noise is raised abruptly by an increase in the torque of the engine 1. Such predetermined amount is determined based on a result of experiment, and it may be a fixed value but also a variable value that varies in accordance with change in a traveling noise that is changed with a change in a speed of the vehicle Ve.

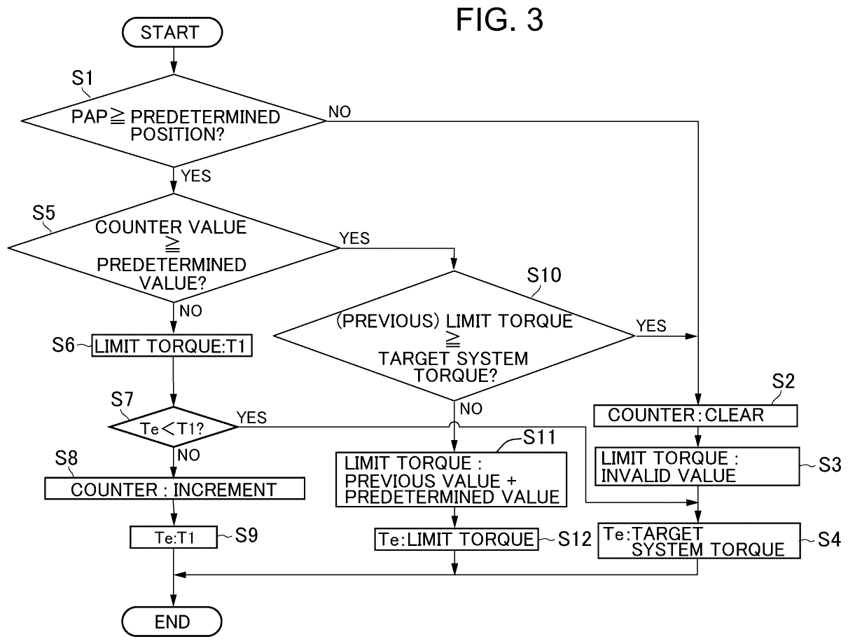

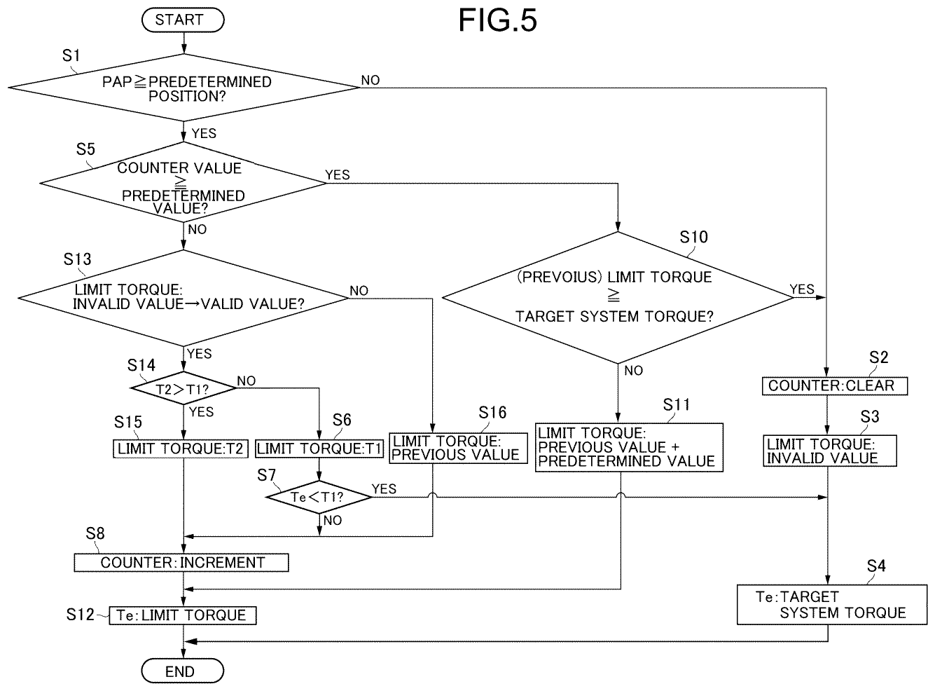

Turning to FIG. 3, there is shown one example of a routine executed by the controller 13. At step S1, it is determined whether a position of the accelerator pedal (referred to as PAP in FIGS. 3 and 5) is deeper than a predetermined position determined in accordance with a vehicle speed. That is, at step S1, it is determined whether or not the driver has depressed the accelerator pedal with the intention to accelerate the vehicle Ve.

If the position of accelerator pedal is shallower than the predetermined position so that the answer to the step S1 is NO, the routine progresses to step S2 to clear an after-mentioned elapsed time counter, and further progresses to step S3 to set a limit torque of the engine 1 to an invalid value. The limit torque of the engine 1 is set to realize the behavior of the vehicle Ve expected by the driver, and an upper limit torque governed by a structure of the engine 1 is set continuously. The routine further progresses to step S4 to set the engine torque Te to the target system torque, and thereafter returns.

By contrast, if the position of the accelerator pedal is the predetermined position or deeper so that the answer of the step S1 is YES, the routine progresses to step S5 to determine whether a value of the elapsed time counter is equal to or greater than a predetermined value. Specifically, the elapsed time counter is configured to measure an elapsed time as a predetermined period of time of the preset disclosure from a point at which the engine torque Te reaches an after-mentioned limit torque, and the predetermined value is set to a value corresponding to a period by which the driver is allowed to perceive that the vehicle Ve is accelerated by the output torque of the motor 2 as intended. Such predetermined value is determined based on a result of an experiment conducted in advance. Therefore, if the position of the accelerator pedal is the predetermined position or deeper so that the answer of the step S1 in the first routine is YES, the answer of subsequent step S5 will be NO.

If the value of the elapsed time counter is less than the predetermined value so that the answer of step S5 is NO, the routine progresses to step S6 to set the limit torque of the engine 1 to the sound pressure limiting torque T1. Specifically, the limit torque of the engine 1 is set to the upper limit value of the torque of the engine 1 by which the sound pressure level is suppressed to the level at which the driver cannot perceive the engine noise.

Then, the routine progresses to step S7 to determine whether the engine torque Te is less than the sound pressure limiting torque T1. That is, it is determined at step S7 whether the engine torque Te has increased to the limit torque. For example, the engine torque Te may be measured by a torque sensor arranged on the output shaft 4. Instead, the engine torque Te may also be estimated based on a fuel injection amount to the engine 1 and an air intake amount to the engine 1, or based on a command signal transmitted to the engine 1.

If the engine torque Te is less than the sound pressure limiting torque T1 so that the answer of the step S7 is YES, the routine progresses to step S4 to set the engine torque Te to the target system torque. By contrast, if the engine torque Te is equal to or greater than the sound pressure limiting torque T1 so that the answer of step S7 is NO, the routine progresses to step S8 to increment the elapsed time counter. The routine further progresses to step S9 to set the engine torque Te to the sound pressure limiting torque T1, and thereafter returns. Consequently, the engine torque Te is maintained constant.

Whereas, if the value of the elapsed time counter is equal to or greater than the predetermined value so that the answer of step S5 is YES, the routine progresses to step S10 to determine whether the previous value of the limit torque is equal to or greater than the target system torque. As will be described later, the limit torque of the engine 1 will be gradually increased by executing after-mentioned step S11, and the engine torque Te will also be increased with such increase in the limit torque. At step S10, therefore, it is determined whether the engine torque Te has reached the target system torque and hence the engine torque Te is no longer necessary to be restricted.

If the previous value of the limit torque is equal to or greater than the target system torque so that the answer of step S10 is YES, the routine progresses to step S2 to clear the elapsed time counter. Then, the routine further progresses to step S3 to set the limit torque of the engine 1 to an invalid value. By contrast, if the previous value of the limit torque is less than the target system torque so that the answer of step S10 is NO, the routine progresses to step S11 to increase the limit torque of the engine 1 by the predetermined amount. At step S11, specifically, the predetermined value is added to the previous value of the limit torque of the engine 1, and the routine further progresses to step S12 to set the engine torque Te to the limit torque to which the predetermined value is added. Thereafter, the routine returns. Thus, the limit torque of the engine 1 is increased by the predetermined amount, and the engine torque Te is set to the limit torque increased by the predetermined amount.

If the limit torque of the engine 1 set at step S6 or step S12 is smaller than the lower limit torque of the engine 1 set by the lower guard determiner 19, the engine torque Te is set to the lower limit torque set by the lower guard determiner 19. That is, in order to achieve the required drive force in priority to suppress an increase in the engine noise, the engine torque Te is set to the lower limit torque (lower limit value) in priority to the limit torque (upper limit value).

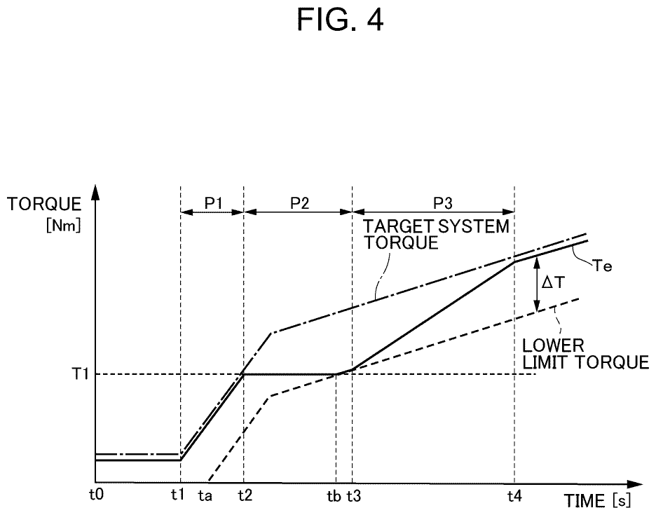

In FIG. 4, there is shown a temporal change in the engine torque Te during execution of the routine shown in FIG. 3. At point to, the vehicle Ve is cruising in the HV mode. In this situation, a position of the accelerator pedal is still shallower than the predetermined position so that the answer of step S1 in the routine shown in FIG. 3 is NO. Therefore, the engine torque Te indicated by the solid line is not restricted, and substantially identical to the target system torque indicated by the dashed-dotted line. At point to, the target system torque may be achieved only by the torque of the motor 2. Therefore, at point to, the engine torque Te is not restricted by the lower limit torque.

At point t1, the accelerator pedal is depressed so that the target system torque starts increasing. Consequently, the engine torque Te starts increasing from point t1 with the increase in the target system torque. In this situation, the routine shown in FIG. 3 progress from step S1 to step S6 via step S5 so that the limit torque of the engine 1 is set to the sound pressure limiting torque T1. In the first phase P1 in which the engine torque Te is less than the sound pressure limiting torque, the routine shown in FIG. 3 progresses from step S7 to step S4 so that the engine torque is controlled to achieve the target system torque.

When the engine torque Te is increased to the sound pressure limiting torque T1, the routine shown in FIG. 3 progresses from step S7 to step S8 to start incrementing the elapsed time counter. In addition, the engine torque Te is set to the sound pressure limiting torque T1. That is, the engine torque Te is maintained to the sound pressure limiting torque T1 while the target system torque is increasing. In other words, the increase in the engine torque Te is suppressed. Consequently, a difference develops between the target system torque and the engine torque Te. In this situation, therefore, the motor 2 generates a torque corresponding to the difference between the target system torque and the engine torque Te. In the first phase P1 from point t1 to point t2, the target system torque is larger than the maximum torque of the motor 2. Therefore, the engine torque Te is guarded by the lower limit torque indicated by the broken line from point ta.

In the second phase P2 from point t2 to point t3, the value of the elapsed time counter is less than the predetermined value. Therefore, in the second phase P2, the engine torque Te is limited continuously to the sound pressure limiting torque T1. In this situation, the lower limit guard value exceeds the sound pressure limiting torque T1 at point tb. Consequently, the engine torque Te increases slightly from point tb with an increase in the lower limit guard value. That is, the target system torque is achieved on a priority basis. In FIG. 4, the maximum torque of the motor 2 is indicated as ΔT.

At point t3, the value of the elapsed time counter increases to the predetermined value so that the routine shown in FIG. 3 proceeds from step S5 to step S10. In this situation, the limit torque is set to the sound pressure limiting torque T1 which is smaller than the target system torque. Therefore, the routine shown in FIG. 3 progresses from step S10 to step S11. Consequently, in the third phase P3 from point t3 to point t4, the limit torque starts to be increased by the predetermined amount from the sound pressure limiting torque T1, and the engine torque Te increases in accordance with the increase in the limit torque. In the example shown in FIG. 4, since an increasing rate of the limit torque is higher than that of the target system torque, the difference between the target system torque and the engine torque Te is reduced gradually.

At point t4, the engine torque Te is increased to the target system torque so that the routine shown in FIG. 3 progresses from step S10 to step S2 to clear the elapsed time counter. Consequently, the limit torque is set to an invalid value, and the engine torque Te is increased in accordance with the increase in the target system torque.

Thus, when the driver depresses the accelerator pedal to increase driving force to propel the vehicle Ve, in the first phase P1 where the engine torque Te is less than the sound pressure limiting torque T1, the engine torque Te is increased in accordance with an increase in the target system torque. In this situation, therefore, it is not necessary to generate a large torque by the motor 2 so that the power consumption may be reduced.

In the second phase P2 after the engine torque Te reaches the sound pressure limiting torque T1, the engine torque Te is maintained to the sound pressure limiting torque T1. Therefore, the driver or the occupant may have an impression that the engine 1 is not activated or that the engine 1 is not generating the driving torque. In this situation, since the motor 2 generates a torque to offset the shortage, the driving force to propel the vehicle Ve is increased to achieve the required drive force (i.e., the target system torque). Therefore, the driver has an impression that the vehicle Ve is propelled by the driving torque generated by the motor 2. That is, the behavior of the hybrid vehicle propelled by the motor 2 may be realized as intended by the driver.

Further, since the engine torque Te is increased to the sound pressure limiting torque T1 and the motor 2 generates the torque to achieve the target system torque, an increase in the torque required to be generated by the motor 2 may be suppressed. Therefore, even if the hybrid vehicle is provided with a motor having a small capacity, an expected behavior of the hybrid vehicle may be realized.

Furthermore, the torque calculated by subtracting the maximum torque of the motor 2 from the target system torque is set as the lower limit guard value of the engine torque Te, and the engine torque Te is controlled in accordance with the lower limit guard value when the lower limit guard value exceeds the sound pressure limiting torque T1 as the limit torque of the engine 1. Therefore, the driving force required by the driver may be generated to achieve the target system torque for propelling the vehicle Ve in priority to reduce the engine noise.

As described, the predetermined position for determining that the driver depressed the accelerator pedal to accelerate the vehicle Ve is set to a deeper position with an increase in a speed of the vehicle Ve. Therefore, in a situation where the accelerator pedal is depressed to accelerate the vehicle Ve cruising at a high speed, the engine torque (i.e., the determination torque T2) generated in accordance with the position of the accelerator pedal may be larger than the sound pressure limiting torque T1. In such case, if the limit torque of the engine 1 is set to the sound pressure limiting torque T1, the engine torque Te will be reduced when the execution of the above-mentioned accelerating operation is determined, and consequently the engine noise will be changed significantly. In order to avoid such disadvantage, the driving force control system according to the exemplary embodiment of the present disclosure is configured to set the limit torque of the engine 1 to the determination torque T2 in the situation where the determination torque T2 is larger than the sound pressure limiting torque T1.

To this end, the controller 13 executes the routine shown in FIG. 5. In the following descriptions, explanations for the steps in common with those in the routine shown in FIG. 3 will be omitted. According to the example shown in FIG. 5, if the value of the elapsed time counter is less than the predetermined value so that the answer of step S5 is NO, the routine progresses to step S13 to determine whether the limit torque is changed from an invalid value to a valid value. Specifically, it is determined at step S13 whether or not the limit torque has been set in the previous routine.

If the limit torque is changed from the invalid value to the valid value so that the answer of step S13 is YES, the routine progresses to step S14 to determine whether the determination torque T2 is larger than the sound pressure limiting torque T1. If the determination torque T2 is larger than the sound pressure limiting torque T1 so that the answer of step S14 is YES, the routine progresses to step S15 to set the limit torque to the determination torque T2, and further progresses to step S8 to increment the elapsed time counter.

By contrast, if the determination torque T2 is equal to or less than the sound pressure limiting torque T1 so that the answer to step S14 is NO, the routine progresses to step S6.

Whereas, if the limit torque is not changed from the invalid value to the valid value, in other words, if the limit torque of the engine 1 has already been set in the previous routine, the routine progresses from step S13 to the step S16 to maintain the previous value of the limit torque. Thereafter, the routine further progresses to step S8.

Thus, according to the routine shown in FIG. 5, the limit torque is set to any one of the determination torque T2 and the sound pressure limiting torque T1 in the case that the answer of the step S5 is NO. Therefore, the above-mentioned step S9 for setting the engine torque Te to the sound pressure limiting torque T1 is omitted.

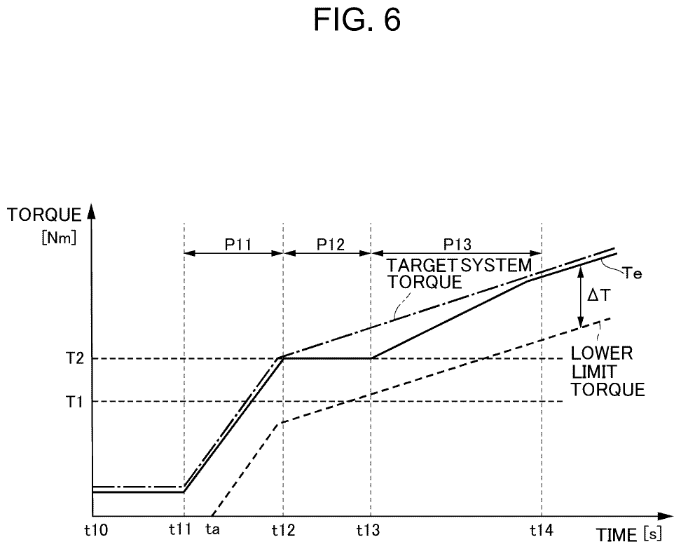

In FIG. 6, there is shown a temporal change in the engine torque Te in the case that the determination torque T2 is larger than the sound pressure limiting torque T1. At point t10, the vehicle Ve is cruising in the HV mode. In this situation, a position of the accelerator pedal is still shallower than the predetermined position so that the answer of the step S1 in the routine shown in FIG. 5 is NO. Therefore, the engine torque Te indicated by the solid line is not restricted, and substantially identical to the target system torque indicated by the dashed-dotted line. At point t10, the target system torque may be achieved only by the torque of the motor 2. Therefore, at point t10, the engine torque Te is not restricted by the lower limit torque.

At point t11, the accelerator pedal is depressed so that the target system torque starts increasing. Consequently, the engine torque Te starts increasing from point t11. At point t12, the accelerator pedal is depressed to the predetermined position at which an execution of the accelerating operation is determined. Therefore, in the first phase P11 from point t11 to point t12, the answer of the step S1 is always NO so that the engine torque Te is not restricted and substantially identical to the target system torque.

When the accelerator pedal is depressed to or deeper than the predetermined position at point t12, an affirmative determination is made at step S1. In this example, since the determination torque T2 is larger than the sound pressure limiting torque T1, the routine progresses from step S14 to step S15 in the routine shown in FIG. 5. In this situation, therefore, the engine torque Te is restricted to the determination torque T2 in the phase P12 from point t12 to point t13. In other words, the increase in the engine torque Te is suppressed. Consequently, a difference develops between the target system torque and the engine torque Te. In this situation, therefore, the motor 2 generates a torque corresponding to the difference between the target system torque and the engine torque Te. In the first phase P11 from point t11 to point t12, the target system torque is larger than the maximum torque of the motor 2. Therefore, the engine torque Te is guarded by the lower limit torque indicated by the broken line from point ta.

Then, at point t13, the value of the elapsed time counter is increased to the predetermined value. Therefore, the routine progresses from step S5 to step S10. In this situation, the limit torque is set to the determination torque T2 and is less than the target system torque. Therefore, the routine progresses from step S10 to step S11. Consequently, in the third phase P13 from point t13 to point t14, the limit torque starts to be increased by the predetermined amount from the determination torque T2, and the engine torque Te increases in accordance with the increase in the limit torque. In the example shown in FIG. 6, since an increasing rate of the limit torque is higher than that of the target system torque, the difference between the target system torque and the engine torque Te is reduced gradually.

At point t14, the engine torque Te is increased to the target system torque so that the routine progresses from step S10 to step S2 to clear the elapsed time counter. Consequently, the limit torque is set to an invalid value, and the engine torque Te is increased in accordance with the increase in the target system torque.

Thus, when the determination torque T2 is larger than the sound pressure limiting torque T1, the engine torque Te is maintained to the determination torque T2. Therefore, the engine torque Te will not be increased after the execution of the accelerating operation is determined. That is, an increase in the engine noise may be suppressed. Consequently, the driver has an impression that the vehicle Ve is propelled by the driving torque generated by the motor 2. That is, it is possible to realize the behavior of the hybrid vehicle propelled by the motor 2 as intended by the driver. In addition, since a reduction in the engine torque Te is prevented, an unintentional change in the engine noise or driving force may be prevented.

The driving force control system according to the exemplary embodiment of the present disclosure may also be applied to a hybrid vehicle in which the motor is connected to a rotary shaft to which torque is delivered from the engine through the transmission mechanism, instead of the above-explained hybrid vehicle in which the torques of the engine and the motor are delivered to the transmission mechanism. In this case, in order to execute the foregoing examples, a target value of the torque of the output shaft of the transmission mechanism may be employed as the target system torque, and a torque transmitted to an output side of the transmission mechanism may be calculated by multiplying an engine torque by a speed ratio of the transmission mechanism.

Further, the driving force control system according to the exemplary embodiment of the present disclosure may also be applied to a hybrid vehicle in which torque is transmitted from an engine to a pair of front wheels and torque is transmitted from a motor to a pair of rear wheels. In this case, a speed ratio between the engine and the pair of front wheels may be different from a speed ratio between the motor and the pair of rear wheels. Therefore, in order to execute the foregoing examples, a target value of the torque of an output shaft of any one of the engine and the motor may be employed as the target system torque, and a torque transmitted to the output shaft of one of the engine and the motor may be calculated by multiplying a torque of the other one of the engine and the motor by a speed ratio of the transmission mechanism.

What is claimed is:

1. A driving force control system for a hybrid vehicle having a prime mover including an engine and a motor that generates a system torque to achieve a required driving force to propel the hybrid vehicle, comprising:
a controller that controls torques of the engine and the motor,
wherein the controller comprises
a first acceleration controller that is configured to increase the torque of the engine to a predetermined torque with an increase in the system torque,
a second acceleration controller that is configured to restrict the torque of the engine which has been increased to the predetermined torque to the predetermined torque or less within a predetermined period of time, and
a third acceleration controller that is configured to increase the torque of the engine which has been restricted by the second acceleration controller to achieve the system torque.

2. The driving force control system for the hybrid vehicle as claimed in claim 1, wherein the controller further comprises:
a lower guard determiner that is configured to set a lower limit torque of the engine to a torque calculated by subtracting a torque corresponding to the maximum torque of the motor from the system torque.

3. The driving force control system for the hybrid vehicle as claimed in claim 1, wherein the predetermined torque includes a torque by which a sound pressure level of noise generated by operating the engine is suppressed to a maximum sound pressure level at which the noise of the engine cannot be perceived by an occupant.

4. The driving force control system for the hybrid vehicle as claimed in claim 1,
wherein the controller further comprises an acceleration determiner that is configured to determine that a driver has an intention to accelerate the hybrid vehicle based on a fact that a target value of the system torque is increased to a predetermined determination torque or larger, and
the predetermined torque includes the determination torque.

5. The driving force control system for the hybrid vehicle as claimed in claim 4, wherein the determination torque is set to a larger torque with an increase in a speed of the hybrid vehicle.
